(19) United States
(12) Patent Application Publication
(10) Pub. No.: US 2003/0214258 A1
(43) Pub. Date: Nov. 20, 2003

(54) Selective emitter with electrical stabilization and switching

(76) Inventor: Devon R. McIntosh, Accokeek, MD (US)

Correspondence Address: Devon R. McIntosh, 17609 Clinton Drive, Accokeek, MD, 20607, US

(21) Appl. No.: 10/143,949

(22) Filed: May 14, 2002

(51) Int. Cl. H05B 39/04

(52) U.S. Cl. 315/291

(57) ABSTRACT

The invention provides an incandescent electromagnetic radiation source comprising a non-metallic emitter body that conducts electricity, and an emitting volume within the emitter body that has a thermal energy, optical absorption coefficients, and optical scattering coefficients, and that generates and externally emits electromagnetic radiation. An electric current is applied to the emitting volume such that a substantial portion of the thermal energy is generated by electrical resistive heating within the emitting volume. The optical absorption coefficients have significantly larger values within a predetermined high emissivity portion of the electromagnetic spectrum than within a predetermined low emissivity portion of the spectrum, and the optical scattering coefficients have much larger values than the optical absorption coefficients within the predetermined low emissivity portion of the spectrum. Also, to provide electrical stability and electrical switching, a resistance inverting switching device is used. The device comprises a variable resistance element, at least one output load, at least one resistance sensing device whereby changes in the resistance of the variable resistance element is sensed, and at least one electronic switching element that switches the load current on and off. Electrical interconnections between the switching element and the resistance sensing device causes the switching element to decrease the length of time that the load conducts current when the electrical resistance of the variable resistance element decreases, and to increase the length of time that the load conducts current when the electrical resistance of the variable resistance element increases.

### BACKGROUND OF THE INVENTION

1. Field of the Invention

This invention relates generally to incandescent electromagnetic (E-M) radiation sources and electrical switching circuits. More specifically this invention relates to selective incandescent emitters that preferentially radiate within a selected portion of the E-M spectrum, and to electrical power controllers and switching.

2. General Background and Description of Related Art

For an emitter of thickness d that has spectral absorption coefficients a_{ν} at frequency ν, which is much larger than its optical scattering coefficient σ_{ν}, the spectral emissivity, ε_{ν}, at frequency νis given by, ε_{ν}=(1−R)(1−T)/(1−RTₐ). R is the surface reflectivity and Tₐ, being the transmissivity, is given by exp(−a_{ν}d). Therefore, by utilizing the appropriate first order expansions, for optically thin media (i.e. a_{ν}d<<1, yielding minimal absorption of internally generated radiation) with negligible optical scattering, we get an emissivity equal to a_{ν}d, and for optically thick media (i.e. a_{ν}d>>1, yielding almost total absorption of internally generated radiation) we get an emissivity equal to 1−R. The spectral emissivity of an object that absorbs perfectly (i.e. R=0) at all wavelengths is a constant value of one. The object is called a blackbody, and its spectral intensity distribution is given by the Plank blackbody distribution.

For an incandescent body radiating at a particular temperature, the power radiated as a function of wavelength is the product of the emissivity and the Plank blackbody spectral distribution. The Plank distribution varies strongly with temperature, and therefore, so does the radiated intensity. The hotter the blackbody, the shorter the median wavelength of its radiated spectrum. For example, up to about solar temperatures (5776 K), the visible-to-infrared (VIS/IR) radiant power ratio increases with temperature. Since thermal material properties limit practical incandescent lighting to temperatures less than about 3100 K (a standard 100 W tungsten bulb operates at about 2770 K), significant improvements in the VIS/IR ratio require making the emissivities within the near infrared (NIR) much smaller than those within the visible spectrum. Selective emitters are incandescent radiant bodies with emissivities that are substantially larger in a selected portion of the spectrum, thereby significantly shifting their radiated spectral distribution from that of a blackbody radiating at the same temperature.

One means of attaining selective emissivity within the VIS is to construct optically thick emitters from materials with reflectivity R larger within the NIR than within the VIS (the emissivity of an optically thick emitter is 1−R). However, the relatively small variations in R exhibited by most refractory materials within the visible and NIR regions are not enough to provide significant selectivity. The tungsten-filament emitter used in standard incandescent light bulbs is an example. Its emissivity, which is almost two times greater within the VIS than within the NIR, provides very little selectivity because even at 2770 K, the total power within the NIR of the Plank distribution is an order of magnitude greater than that within the VIS.

An optically thick emitter resulting in better selectivity than tungsten is the Nernst Glower (Ropp 1993, and Solomon 1912). Commercially produced from 1902 to 1912, it consists of a ceramic oxide composite (zirconia, thoria, ceria and yttria) filament that glows brightly when resistively heated to up to 2650 K by an electric current. Typical lamp life, which is limited by electrolysis of the oxides during operation, is about 800 hours. Thermal failure of the electrodes (i.e. the electrical leads), which are drawn from platinum, can also be a problem. Though its VIS/NIR radiant power ratio is grater than that of tungsten, the glower has a negative temperature coefficient of resistance, which, without adequate ballast, causes thermal runaway to catastrophically high temperatures. A wire-wound ballast resistor having a positive current vs. voltage curve is used. However, energy loss within the ballast decreases overall energy efficiency to about half that of tungsten bulbs, and while modem electronic ballast have been developed for fluorescent lighting, none have been developed for incandescent lighting. Moreover, since electrical conduction within the ceramic composition occurs only at high temperatures, a separate heater is required to attain “turn-on” temperatures (i.e. the minimum temperature at which the ceramic composition appreciably conducts).

Another means of attaining selective emissivity is to utilize optically thin emitters. Optically thin selective emitters are important because their spectral emissivities are a direct function of their spectral absorptivities, which can vary by orders of magnitude. One well-known approach to exploiting the spectral selectivity of certain optically thin ceramic oxides is to heat the emitters within a gas flame that does not itself radiate extensively within the NIR. Known as the Welsbach mantle, a mixture of ceramic oxides (mainly zirconia, thoria and ceria) is impregnated within thin gauze strands and arranged within a cylindrical framework. When first lit, the gauze burns away, leaving the ceramic composition in the form of thin strands. Since, for zirconia, thoria and ceria, the spectral absorptivity is well over two orders of magnitude greater within the VIS than within the NIR, and since the ceramic strands constitute optically thin emitters with spectral emissivity proportional to spectral absorptivity, the mantles radiate at significantly greater VIS/NIR radiant power ratios than tungsten bulbs. But since gas flame heating is unsuitable for general lighting purposes the lanterns are limited to mainly outdoor recreational use. The patent of Fok (1970) is another example of a special purpose (i.e. miniature lighting) optically thin, selective emitter, but in this case, a semiconductor, instead of ceramic oxides compose the emitter body. The rear-earth oxide emitters discussed by Chubb et al. (1999), present other examples of special purpose (i.e. thermophotovoltaic energy conversion) optically thin selective emitters. In this case the emitters are optimized for selective emissivity within the NIR.

A relatively recent approach to selective emissivity that combines the potentially high selectivity of optically thin emitters with the versatility of thick emitters is to utilize significant optical scattering within materials having large variations in spectral absorptivity (see Warren et al. 1976, Riseberg 1985, Chubb and Lowe 1993, or McIntosh, 2000). With this approach, an optically thick emitter can radiate as if optically thin because scattering limits the distance below the surface from which significant amounts of internally generated radiation can emerge. Unlike the case with no internal scattering, with scattering an optically thick medium can exhibit a selective emissivity that is a function of its spectral absorption coefficient, a_{ν}. This is important because oxides such as zirconia and ceria have absorption coefficients that can be two to three orders of magnitudes greater within the VIS than within the NIR. However, a mathematical description of such emitters requires a radiation transfer model. A formulation of such a model was solved in closed form by Chubb and Lowe (1993) to obtain a general expression for the spectral emissivity. In FIG. 13, ε_{ν} (the spectral emissivity) is plotted as a function of z_{ν} (the scattering albedo) for an optically thick body with z_{ν}=σ/(a_{ν}+σ) (a_{ν} is the spectral absorption coefficient and σ is the scattering coefficient). As z_{ν} approaches 1, ε_{ν} decreases by many orders of magnitude. Therefore, for high selectivity, 1−z_{ν} should be roughly two to three orders of magnitude smaller than 1 in the desired low emissivity portion of the emission spectrum, and a_{ν} should have values roughly two to three orders of magnitude greater within the desired high emissivity portion of the spectrum than its values within the low emissivity portion of the spectrum. Since σ does not vary significantly with wavelength, this requires a substantial decrease in a_{ν} as ν transitions from the VIS to the NIR (assuming the VIS is the desired high emissivity portion of the spectrum). For zirconia and ceria, a_{ν} decreases by approximately three orders of magnitude.

Only a few published reports describe attempts to enhance spectral selectivity by introducing significant optical scattering within incandescent emitters (Warren et al. 1976, Riseberg 1985, McIntosh 2000). Riseberg discloses a candoluminescent filament with a carbonized resistive core, wherein the sheath surrounding the core contains a porous structure that one supposes could provide some degree of optical scattering. However, nowhere within the disclosure is there mention of utilization of the porous structure to provide any optical scattering or enhancement of spectral selectivity. Moreover, due to the carbon-thoria and the carbon-ceria makeup of the filament, and the fact that the maximum temperature at which phase stability at the carbon interfaces exists is only about 2250 K, sufficiently high temperatures cannot be maintained to provide the desired efficiency improvements.

In Warren et al. (1976), the core of the emitter contains a metal-ceramic oxide composite that is resistively heated via an electric current and that conducts heat to the outer emitting portion, which has a plurality of spaced minute optical scattering discontinuities and optical absorption coefficients such that visible radiation is substantially absorbed while traversing the distance between scattering discontinuities. However, similarly to Riseberg (1985), phase instabilities at the metal-ceramic interface do not allow stable operation above 2200 K. Another fundamental problem for Warren (as well as for Riseberg) is the reliance on thermal conduction between a heating component (the emitter core) and an emitting component (the outer sheathe), which are chemically different, and therefore cannot maintain interface stability at sufficiently high temperatures. This problem is a result of being unable to directly heat the emitting layer via stable electrical resistive heating.

McIntosh (2000) describes a selective emitter having absorption and scattering coefficients consistent with the radiative transfer design suggested by FIG. 13 and described above. The body of the disclosed Multi-Element Selective Emitter (MESE) is structured in the form of a hollow bi-layer tube with a tungsten heating coil enclosed within. The coil does not physically contact the tube, thereby avoiding thermally activated surface-to-surface corrosion. Heating is accomplished by radiant energy transfer; however, this approach yields maximum outer layer temperatures of less than 2200 K. Consequently, the VIS/NIR radiant power ratio is no greater than that of a standard tungsten bulb operated at 2770 K.

### SUMMARY OF THE INVENTION

The invention provides an incandescent selective emitter having an electrically conducting externally emitting body that is directly resistively self-heated, and that contains significant optical discontinuities such that the relative values of its optical scattering and absorption coefficients allow substantial selectivity within the relevant E-M spectrum. In the preferred embodiment, direct resistance heating of the emitter body is accomplished by connecting electrodes across and conducting a current through the emitter. This approach overcomes the need to depend on radiant heating, which proved insufficient with the MESE (McIntosh 2000), and overcomes the need to depend on thermal conduction between two dissimilar materials, which proved unstable at high temperatures with the emitters disclosed by Warren et al. (1976) and Riseberg (1985). Selective emissivity is accomplished by utilizing, for the emitter body, a refractory material with spectral absorption coefficients that are much larger within the desired high emissivity portion of the spectrum (i.e. the selected spectrum) than that within the desired low emissivity portion of the spectrum. Significant scattering is introduced by incorporating many minute pores within a multicrystalline body. Wide band-gap materials such as the ceramic oxides zirconia, ceria and thoria, are used for selectivity within the UV-VIS, and a wide band-gap semiconductor such as silicon carbide or rare earth doped ceramics such as ytterbium and thulium doped zirconia (Chubb et al.) are used for selectivity within the VIS-NIR. However, because the conductivity of such materials increases with temperature, without a means of electro-thermal stabilization, thermal runaway to catastrophically high temperatures occur.

Different methods for limiting the emitter current can be used to prevent thermal runaway. For instance, a variety of electronic, magnetic or resistive ballast, which are well known within the art, can be used. Additionally, a novel electronic ballast utilizing a triac to switch off electrical power for longer durations in response to a load with a decreasing resistance is disclosed. This provides a simplified electronic ballast design that is more efficient and cost-effective that one based on fluorescent lamp ballast designs. Also provided is an efficient resistive ballast design obtained by mounting a metal coil resistor within the cylindrical cavity of a tube-shaped emitter body without physically contacting the cavity walls. This allows recovery by the emitter of the heat dissipated by the resistor. A further stabilization approach provided involves applying additional radiant heating to the emitter body during operation. The absorbed radiant power raises the emitter temperature to significantly greater values than would otherwise be possible at that particular emitter current and voltage. Since the radiated power, which is proportional to (temperature)\hat{ }4 is now substantially greater (or, from the other perspective, the resistively generated power, which is proportional to (voltage)\hat{ }2, is now substantially less), thermal power fluctuations are quickly radiated away and do not result in heat buildup and thermal runaway. While an externally positioned electrical coil heater is conceivable for this task, a heater mounted concentrically within a tubular emitter is more efficient.

In oxygen rich atmospheres, ceramic oxides such as zirconia and thoria are solid-state electrolytes that conduct electricity primarily via oxygen ion charge carriers. This can yield oxygen evolution at, and oxidation of the electrodes. But at high temperatures and very low oxygen partial pressures, the oxygen ion component is essentially eliminated and conduction is via electron hopping between stationary oxygen sites within the crystalline lattice. The invention facilitates electronic condition by providing an evacuated or an inert gas enclosure (i.e. a glass bulb) for the emitter, allowing the use of inexpensive metal electrodes such as molybdenum and tungsten (platinum electrodes are used with the Nernst Glower). An oxygen getter is provided to maintain negligibly low oxygen levels.

To minimize electrode-emitter interface instabilities, the electrodes are spatially isolated from the emitter by electrically conducting spatial isolation terminals positioned between the electrodes and the electrical contact points on the emitter body. The isolation terminals are formed from materials exhibiting stable interfaces with both the emitter material and the electrode material at temperatures somewhat below that of the emitter center. This includes terminals formed from the emitter material, in which case the major function is providing thermal insulation between emitter and electrode, or terminals formed from an inert metal, in which case the major function is electrochemical buffering.

At room temperature, ceramic oxides such as zirconia and thoria have high electrical resistances and must be preheated to minimum “turn-on” temperatures, at which point electrical conduction ensues. For the embodiments involving an internally mounted electrical coil, this arrangement allows using the coils as pre-heaters. The other embodiments are heated with externally mounted heating coils. The need for preheating requires a resistance change sensing device that signals a switching device to modify the heater current (typically to shut it off) once electrical conduction within the emitter body ensues. Such devices, which are well known within the art, include solid-state relays, electromagnetic relays, bimetallic switches, and electronic switching circuits. A novel electronic switching circuit utilizing triacs to decrease the on-time of electrical power in response to an electrical component having a decreasing resistance is disclosed. Prior art triac switching circuits of comparable simplicity can only increase instead of decrease the on-time.

### BRIEF DESCRIPTION OF THE DRAWINGS

FIG. 1 is a perspective view of physical layout-1 of the invention.

FIG. 2 is a perspective view of physical layout-2 of the invention.

FIG. 3 is a perspective view of physical layout-3 of the invention.

FIG. 4 is a functional diagram showing functional relationships applicable to layout-1 or layout-2.

FIG. 5 is a functional diagram showing an additional functional relationship applicable to layout-1.

FIG. 6 is a functional diagram showing a functional relationship applicable to layout-3.

FIG. 7 is a functional diagram showing an additional functional relationship applicable to layout-3.

FIG. 8 is a schematic circuit diagram applicable to the FIG. 4 functional diagram.

FIG. 9 is a schematic circuit diagram applicable to the FIG. 5 functional diagram.

FIG. 10 is a schematic circuit diagram applicable to the FIG. 6 functional diagram.

FIG. 11 is a schematic circuit diagram applicable to the FIG. 7 functional diagram.

FIG. 12 is a functional diagram that highlights the resistance inversion function of the stabilization circuits.

FIG. 13 is a plot of emissivity as a function of z_{ν} for optically thick scattering media.

### DETAILED DESCRIPTION OF THE INVENTION

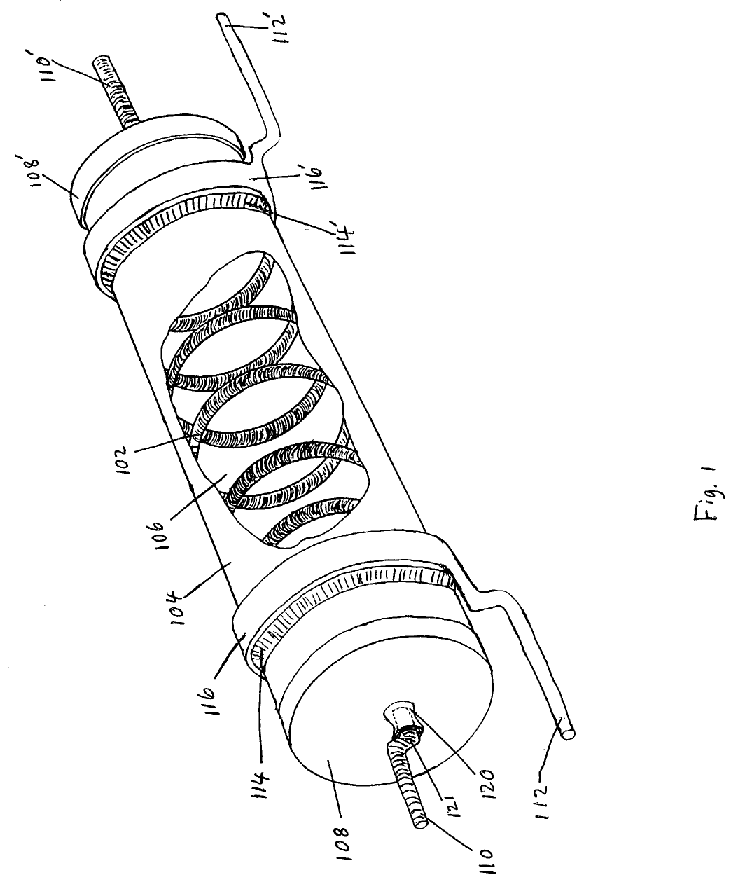

FIG. 1 shows a perspective view of physical layout-1 of the invention, which is a first physical layout of the thermal components of the invention. An internal tungsten heating coil 102 is positioned within a tubular emitter body 104 such that there is no physical contact between the two by threading coil leads 110 and 110′ concentrically through fixed end-caps 108 and 108′. To ensure no sagging, the coil is mounted in a stretched position and fixed in place by utilizing molybdenum crimps 120 applied between a bend in the leads 121 and the end-caps. The end caps help contain radiation within the emitter cavity 106. To prevent electrical conduction between the emitter body and the coil leads, the end-caps are made from a high electrical resistivity refractory oxide such as magnesia or alumina using standard powder pressing techniques. Electrodes 112 and 112′, attached roughly 5 mm from the end of the emitter body, provide electrical current to the middle two thirds of the emitter body without significantly heating the ends. Annular isolation terminals 114 and 114′, formed from the emitter material by extrusion into rings of width greater than the emitter body thickness, are positioned between annular electrode contacts 116 and 116′ and the emitter body to provide thermal insulation between emitter and electrode (the electrode contacts distribute the current from the electrodes to the emitter body).

For all the drawing figures, the emitter body is extruded from a paste obtained by mixing a sucrose solution with a micron grain size powder mixture comprised of 32% by volume yttria stabilized zirconia doped with about 1 volume percent ceria and mixed with 33% by volume each of carbon-black and graphite powder and subsequently sintered at about 1300 C to form a tubular body roughly 30 mm long, 4 mm in diameter, and 0.5 mm thick. The carbon black and graphite powder vaporize during sintering leaving a porous microstructure, and as with the outer layer of the emitter described by McIntosh (2000), yields 1−z_{ν} values of roughly 0.60 within the VIS and 0.0013 within the IR.

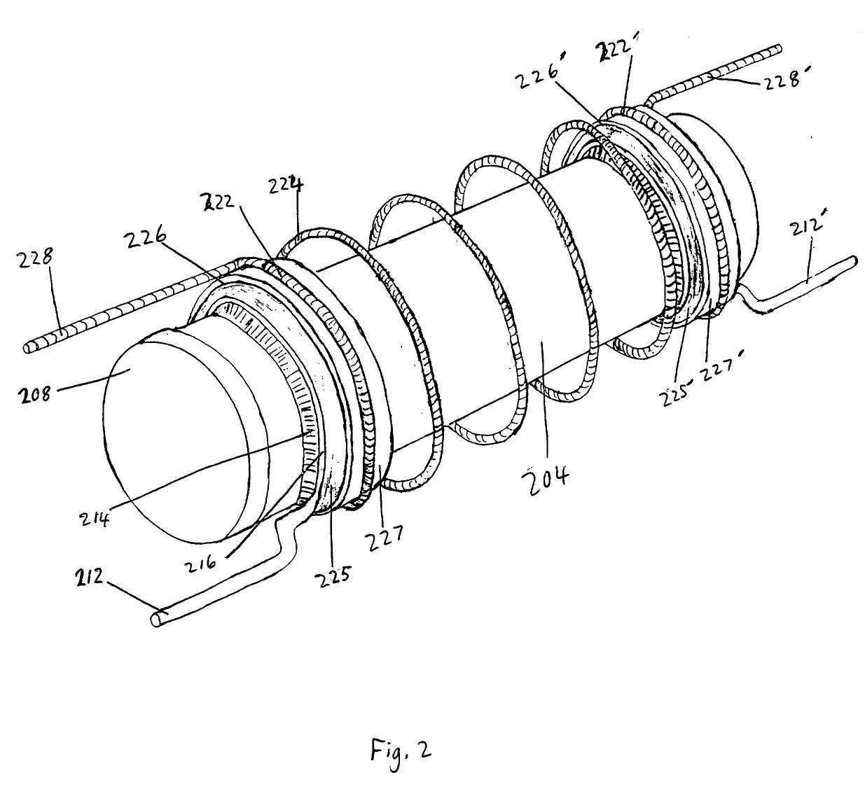

FIG. 2 shows a perspective view of physical layout-2 of the invention, which is a second physical layout of the thermal components of the invention. In this layout, an external tungsten heating coil 224 is positioned externally outside the tubular emitter body 204 such that there is no physical contact between the two. Electrodes 212 and 212′ connected to annular electrode contacts 216 supply electrical current to the emitter body. Annular isolation terminals 214, formed from the emitter material by extrusion, are positioned between annular electrode contacts 216 and the emitter body to provide thermal insulation between emitter and electrode. Bi-layer spacing rings 226 and 226′ positioned between the heating coil's end hoops 222 and 222′, and the electrode contacts 216 maintain concentricity and spacing of the heating coil. The outer layer 227 and 227′ of the spacing rings are thin molybdenum rings whose electrical contact with the end hoops 222 ensure high electrical conductivity in these areas, thereby generating minimal resistive heating in these regions. The inner layers 225 and 225′ of the spacing rings are extruded from alumina or magnesia or other high electrically resistive refractory oxide. End-caps 208 are used to help contain radiation within the emitter cavity (not shown). The external heating coil is connected to electrical power via leads 228 and 228′.

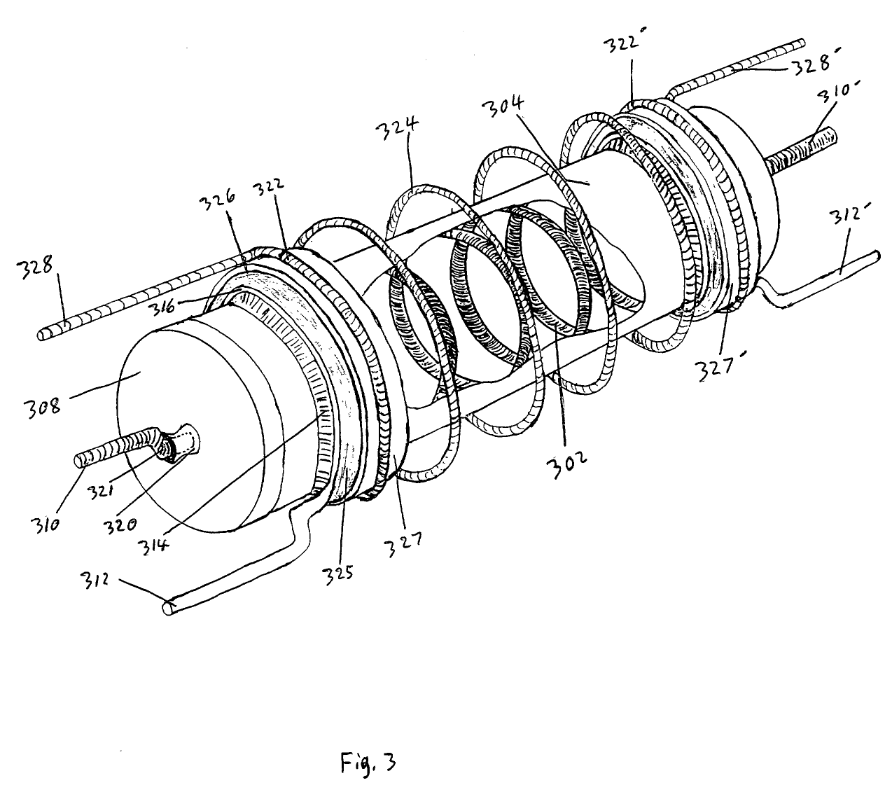

FIG. 3 shows a perspective view of layout-3 of the invention, which is essentially layout-1 with the externally mounted heating coil of layout-2. Internal tungsten heating coil 302 is positioned within a tubular emitter body 304 such that there is no physical contact between the two by threading coil leads 310 and 310′ concentrically through fixed end-caps 308, which are identical to 108. The internal coil is mounted in a stretched position and fixed in place by tubular molybdenum crimps 320 positioned between the end caps and a bend 321 in the coil leads. Electrodes 312 and 312′ attach to ring-shaped electrode contacts 316 roughly 5 mm from the end of the emitter body. Annular isolation terminals 314 are positioned between the electrode contacts 316 and the emitter body. Bi-layer spacing rings 326 positioned between the end hoops 322 and 322′ of external heating coil 324 and the electrode contacts 316 maintain concentricity and spacing of the heating coil. As described for spacing rings 226, the outer layer 327 of the spacing rings are thin molybdenum rings whose electrical contact with the end hoops 322 ensure high electrical conductivity in these areas. The inner layer 325 of the spacing rings is extruded from alumina or magnesia or other high electrically resistive refractory oxide. The external heating coil is connected to electrical power via leads 328 and 328′.

FIG. 4 is a functional diagram showing a first and a second functional layout of the thermal and electrical components applicable to physical layout-1 and physical layout-2 respectively. For functional layout-1, electrical power for the emitter body 404 and the heating coil (in this case heating coil 402 is mounted internally and corresponds to internal coil 102) is derived from voltage source 452. One end of the emitter body is electrically connected to resistance sensing device 440, which senses the emitter body's increase in electrical conductivity when heated to its turn-on temperature by heating coil 402, and signals switching module 442 (which is connected to heating coil 402), via interconnection 444. In response, the switching module switches terminal 411 from a high power to a low power. Ballast 450, through which electrical power to the emitter body is routed, via electrode 412, ensures stable emitter operation. Functional layout-2 is exactly the same as for functional layout-1 except that coil 402 now corresponds to outer coil 224, and the low power switched to by switching device 442 corresponds to zero power.

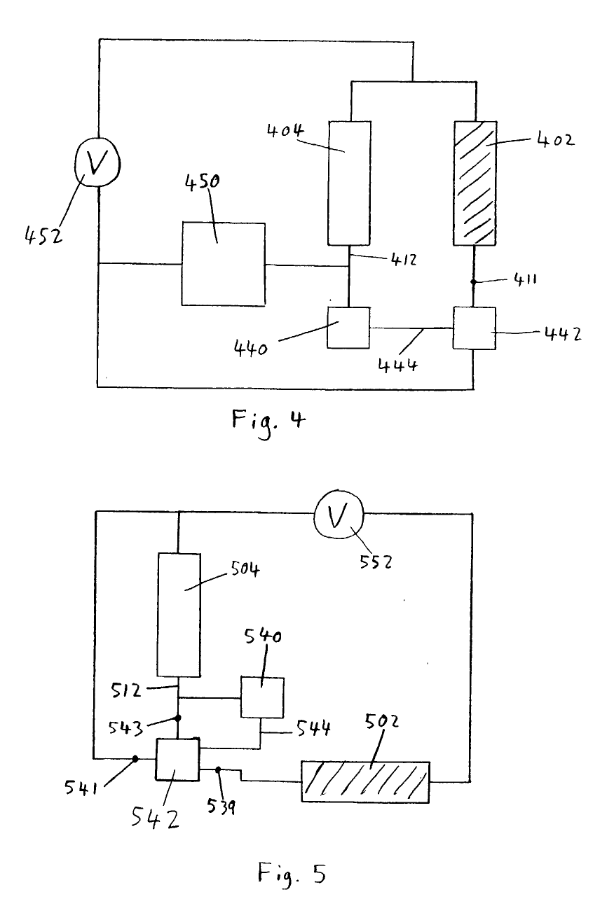

FIG. 5 is another functional diagram showing a third functional layout of the thermal and electrical components applicable to physical layout-1. Prior to the emitter body 504 attaining its turn-on temperature, terminals 541 and 539 are electrically connected via switching module 542 such that internal heating coil 502 is connected directly across the input power source 552. Electrode 512 connects emitter body 504 to resistance sensing device 540, which senses the emitter body's increase in electrical conductivity when heated to its turn-on temperature by internal heating coil 502, and signals switching module 542 via interconnection 544, at which point the switching device severs electrical contact between terminals 539 and 541 and connects terminal 539 to terminal 543 instead. This provides a series connection between the emitter body and the heating coil, and allows use of the internal heating coil as both an emitter body pre-heater and as ballast.

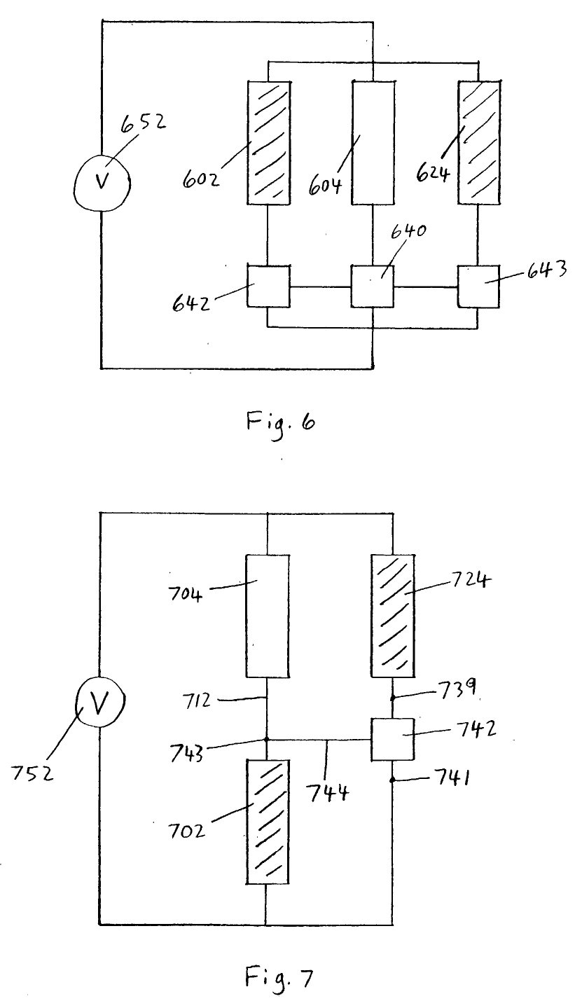

FIG. 6 is a functional diagram showing a fourth functional layout of the thermal and electrical components applicable to physical layout-3. Electrical power for the emitter body 604, external heating coil 624, and internal heating coil 602 is derived from voltage source 652. One end of the emitter body is electrically connected to resistance sensing device 640, which senses the emitter body's increase in electrical conductivity when heated to its turn-on temperature by the heating coils, and signals switching module 642, which is connected to internal heating coil 602, and switching module 643, which is connected to external heating coil 624. In response, switching module 642 switches terminal 611 from a high power to a low power, and switching module 643 disconnects terminal 629 from electrical power. As described above, this configuration does not require separate ballast because of the increase of emitter body temperature attributable to inner heating coil 602.

FIG. 7 is another functional diagram showing a fifth functional layout of the thermal and electrical components applicable to physical layout-3. Prior to the emitter body 704 attaining its turn-on temperature, terminals 741 and 739 are electrically connected via switching module 742 such that external heating coil 724 is connected directly across the input power supply 752. Electrode 712 connects emitter body 704 to internal heating coil 702 in series with input power supply 752. The change in voltage at terminal 743 due to the emitter body's increase in electrical conductivity when heated to its turn-on temperature by external heating coil 724, is communicated to switching device 742 via interconnection 744, at which point the switching module disconnects terminal 739 from electrical power. The internal heating coil functions as ballast in its series connection with the emitter body.

FIG. 8 is a schematic circuit diagram showing a first and a second electrical schematic applicable to functional layout-1 and functional layout-2 respectively of FIG. 4. For functional layout-1 resistor 824 represents internal heating coil 102, and for functional layout-2 resistor 824 represents external heating coil 224. Before emitter body 804 is heated to its turn-on temperature by heating coil 824, capacitor 874 charges quickly enough through resistor 866 to cause diac 862 to fire relatively early in the phase of the AC supply voltage 852 as the phase increases from zero degrees or from 180 degrees. This causes the length of time that triac 843 conducts electricity to be relatively long, which causes heating coil 824 to dissipate a relatively large electrical power.

After emitter body 804 attains its turn-on temperature, its conductivity increase causes a decrease in the voltage between nodes 884 and 886 via resistor 870 (which functions as a resistance sensing device) during the period of time when triac 842 is switched off. This causes slower charging of capacitor 874, and for functional layout-1 where resistor 824 is the internal heating coil, resistor 866 is chosen such that diac 862 fires relatively late in the phase of the supply voltage so as to decrease the power dissipated by heating coil 824 by a predetermined amount. For functional layout-2 where resistor 824 is the external heating coil, resistor 866 is chosen such that capacitor 874 charges so slowly that diac 862 never fires, effectively turning off heating coil 824. For both layout-1 and layout-2, the circuit arrangement yielding an effective decrease in electrical power caused by the increase in emitter conductivity constitutes a resistance inverting switching device that decreases the length of time current flows through the load (i.e. heating coil 824) in response to the resistance decrease of a variable resistance electrical component (i.e. the emitter body 804). In this case the load is distinct from the variable resistance electrical component.

After emitter body 804 attains its turn-on temperature, but before self-heating to its predetermined operating temperature, capacitor 872 charges quickly enough through resistor 864 to cause diac 860 to fire relatively early in the phase of the AC supply voltage as the phase increases from zero degrees or from 180 degrees. This causes the length of time that triac 842 conducts electricity to be relatively long, which causes the emitter body to dissipate a relatively large electrical power. If the emitter body 804 self-heats past its predetermined operating temperature, its conductivity increase causes a larger decrease in the voltage between nodes 884 and 880 via resistor 868 (which functions as another resistance sensing component) during the period of time when triac 842 is switched off. This larger voltage decrease causes slower charging of capacitor 872 such that diac 860 fires relatively late in the phase of the supply voltage so as to decrease the electrical power dissipated by the emitter body and return it to its predetermined operating temperature, thereby providing ballast. In this case the load is the same as the variable resistance electrical component, and the resistance inverting switching circuit is employed as ballast.

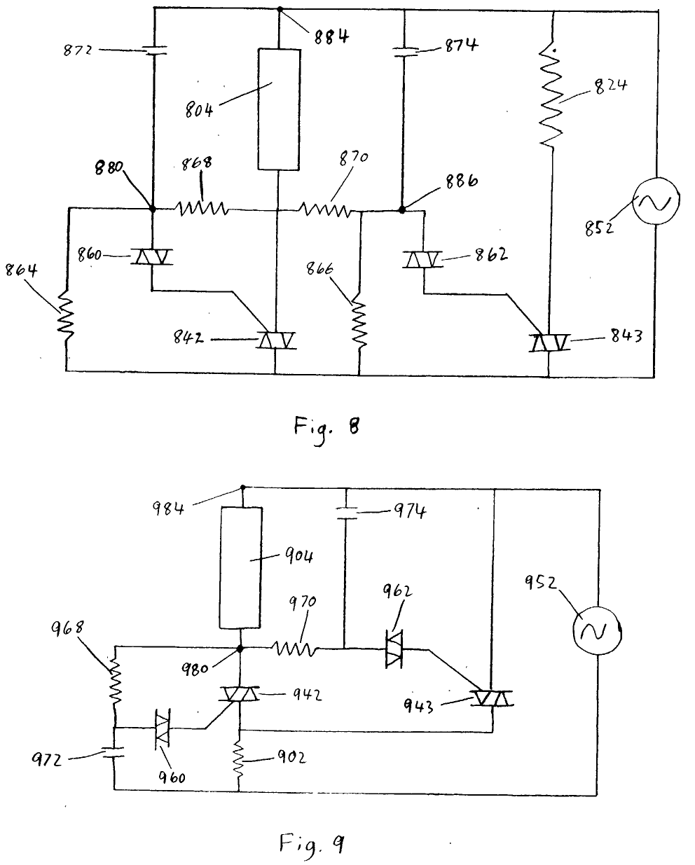

FIG. 9 is a schematic circuit diagram showing a third electrical schematic applicable to functional layout-3 of FIG. 5. Resistor 902 represents internal heating coil 102. Before emitter body 904 is heated to its turn-on temperature by heating coil 902, capacitor 974 charges quickly enough through resistors 970 and 968 (triac 942 is off) to cause diac 962 to fire relatively early in the phase of the AC supply voltage 952. This causes the length of time that triac 943 conducts electricity to be relatively long, which causes heating coil 902 to dissipate a relatively large electrical power. Meanwhile, capacitor 972 is chosen large enough such that it charges too slowly to allow diac 960 to fire, thereby maintaining triac 942 in its off state. After emitter body 904 is heated to its turn-on temperature, its conductivity increase causes a decrease in the voltage between nodes 984 and 980. This causes capacitor 974 to charge so slowly that diac 962 never fires, effectively severing the heating coil's direct connection, via triac 943, across the supply voltage. However, because the voltage at node 980 is now much closer to that at node 984, capacitor 972 can now charge fast enough to cause diac 960 to fire early enough in the phase of the supply voltage to turn on triac 942 for a substantial length of time. This essentially connects the emitter body in series with the heating coil across the supply voltage. In this case, in addition to utilizing a resistance inverting switching arrangement to disconnect the heating coil 902 from direct connection (via triac 943) across the power supply 952, a non-inverting switching arrangement is employed to connect it in series with the emitter body.

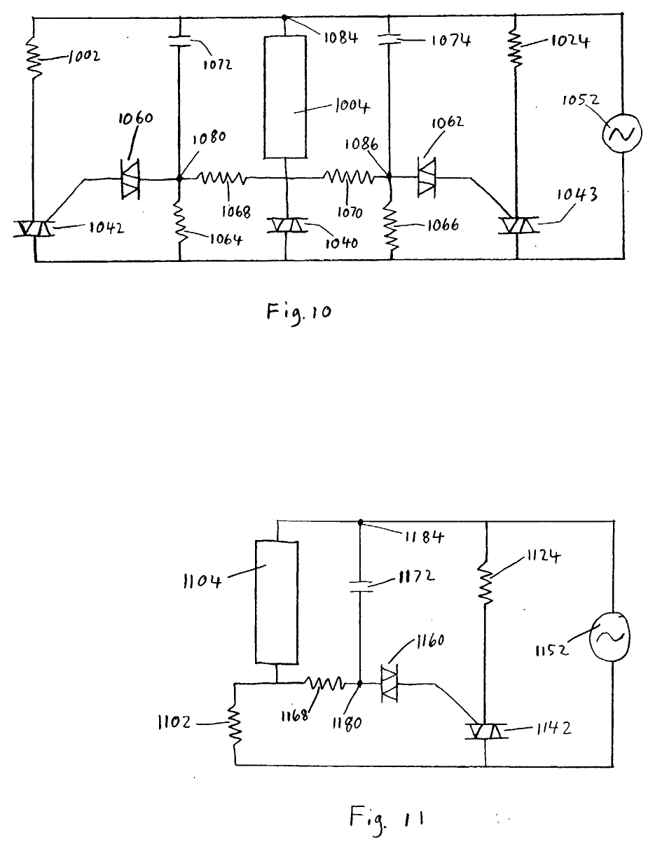

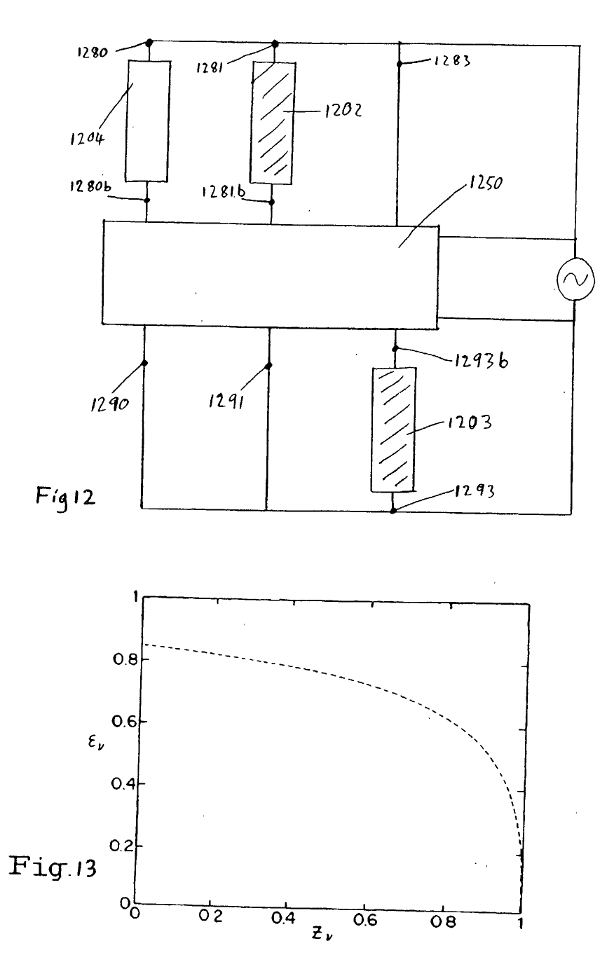

FIG. 10 is a schematic circuit diagram showing a fourth electrical schematic applicable to functional layout-4 of FIG. 6. Resistor 1002 represents internal heating coil 102, and resistor 1024 represents external heating coil 224. Before emitter body 1004 is heated to its turn-on temperature by heating coils 1024 and 1002, capacitors 1074 and 1072 charge quickly enough through resistors 1066 and 1064 respectively to cause diac 1062 and 1060 respectively to fire relatively early in the phase of the AC supply voltage 1052. This causes the length of time that triacs 1043 and 1042 conduct electricity to be relatively long, which causes heating coils 1024 and 1002 to dissipate relatively large amounts of electrical power. After emitter body 1004 attains its turn-on temperature, its conductivity increase causes a decrease in the voltage between nodes 1084 and 1086 via resistance sensing resistor 1070, and between nodes 1084 and 1080 via resistance sensing resistor 1068 during the period of time when diac 1040 is not conducting. This causes slower charging of capacitors 1074 and 1072, such that diac 1062 never fires, effectively turning off heating coil 1024, and such that diac 1060 fires substantially later, effectively decreasing electrical power to heating coil 1002. In this case two different switching modules are used to decrease and disconnect the power from the internal and external heating coils respectively.

FIG. 11 is a schematic circuit diagram showing a fifth electrical schematic applicable to functional layout-5 of FIG. 7. Resistor 1102 represents internal heating coil 102, and resistor 1124 represents external heating coil 224. Before emitter body 1104 is heated to its turn-on temperature by heating coils 1124, capacitor 1172 charges quickly enough through resistor 1168 and heating coil 1102 to cause diac 1160 to fire relatively early in the phase of the AC supply voltage 1152. This causes the length of time that triac 1142 conducts electricity to be relatively long, which causes heating coil 1124 to dissipate a relatively large amount of electrical power. After emitter body 1104 attains its turn-on temperature, its conductivity increase causes a decrease in the voltage between nodes 1184 and 1180. This causes slower charging of capacitor 1172 such that diac 1160 never fires, effectively turning off heating coil 1124.

Nominal values of the various circuit elements are:

| | |
|---|---|
| Triacs (All): | Trigger and latching currents ˜15 mA |
| | Trigger and on-state voltage ˜1 V |
| Diacs (All): | Breakover voltage ˜35 V |
| | Breakover current ˜.1 mA |

Capacitors (All except 972 and 1072): - .1 μF
Capacitor (972): - .15 μF
Capacitor (1072): - .075 μF
Resistor (868): ˜10 kΩ
Resistor (968 and 1168): ˜50 kΩ
Resistors (864, 866, 970, 1062, 1064): ˜100 kΩ
Resistors (870, 1068, and 1070): ˜200 kΩ
Resistor (Internal heating coil): ˜50 Ω
Resistor (External heating coil): ˜150 Ω
Resistor (Emitter body): ˜50 Ω

FIG. 12 is a functional diagram that illuminates the relationships described above between the variable resistance element (i.e. the emitter body) 1204, the resistance inverting switching device 1250, comprising at least one resistance sensing device and at least one switching module, and the output loads 1202 and 1203. Increased conduction in the variable resistance element 1204 causes the switching device 1250 to decrease the length of time that load current flows between nodes 1280 and 1290, thereby effectively decreasing the time-averaged current (the opposite action occurs for increased conduction in the variable resistance element) and providing ballast to the variable resistance element as described in FIG. 8. Increased conduction in the variable resistance element 1204 also causes the switching device to decrease the length of time that load current flows between nodes 1281 and 1291, or between nodes 1283 and 1293, thereby providing the power control functions described in FIGS. 8, 10 and 11. Further switching is also provided to connect or disconnect nodes 1280b, 1281b, and 1283 to any one of nodes 1290, 1291 and 1293b, thereby providing changes in circuit topology similarly to that described in FIG. 9.

The invention is not limited to the particular physical layouts shown in FIGS. 1 to 3. Any layout that allows radiant heating and direct electrical resistive heating of the emitting volume is contemplated by the invention. For instance, the emitter body could be fabricated as a bi-layer tube, either to obtain a particularly absorbing inner layer as with the MESE (McIntosh 2000) or to obtain a thinner emitting outer layer with a low emissivity inner layer, thereby incorporating the advantages of optically thin emitters. Also, the emitter cavity could be pressurized with an inert gas such as argon to extend the life of the internal heating coil. A further example is to incorporate several support rods for the external heating coil that are attached at either end to the inner layer 225 of the bi-layer spacing rings so as to ensure stability of the heating coil. Moreover, the mounting of the emitter need not be constrained to be within a bulb enclosure. As with the Nernst Glower, the utilization of platinum or other stable electrode allows operation within air.

The functional interrelations of the electrical components of the invention are not limited to those shown in FIGS. 4 to 7, instead all configurations are contemplated by the invention that allow various heating coils to radiantly heat the emitter body, and that allow the emitter to operate stably at elevated temperatures. For instance, a constant current source can be used instead of the ballast in FIG. 4, or a separate tungsten incandescent filament with associated switching module could be used to provide near-instant-on lighting until the emitter body heats up, or the external coil in FIG. 5 could be eliminated. The resistance sensing device 440 and the switching module 442 could likewise be eliminated. Also, direct electrical connections to the emitter body could be eliminated by inductively coupling microwave energy to the emitter body similarly to the induction approach used in electrode-less high intensity discharge lighting.

The electronic implementation of the functional diagrams shown in FIGS. 4 to 7 are not limited to the switching circuits shown in FIGS. 8 to 11. For instance, instead of the electronic switching described, electromagnetic relays or bimetallic switches could be used. Other types of ballast such as the resonant designs used with fluorescent lamps can also be utilized. Any electrical arrangement capable of supplying the emitter with a stable current and modifying the current conducted by the heating coils is contemplated by the invention. For instance, a timed switching of the electrical power supplied to the heating coils instead of one triggered by changes in the emitter body's conductivity is an additional possibility.

The electronic implementations of the resistance inverting switching circuits are not limited to those shown in FIGS. 8 to 11. Instead, any implementation such that the function described for FIG. 12 is retained is contemplated by the invention. For instance, the further switching that is provided to connect or disconnect nodes 1280b, 1281b, and 1283 to any one of nodes 1290, 1291 and 1293b could be via electromagnetic relay instead of electronic switching. Moreover, the switching circuits are not limited to the number of input and output devices shown in FIG. 12. More variable resistance elements can be added and the number of loads can be changed.

It can thus be appreciated that the objectives of the present invention have been fully and effectively accomplished. The foregoing specific embodiments have been provided to illustrate the structural and functional principles of the present invention and is not intended to be limiting. To the contrary, the present invention is intended to encompass all modifications, alterations, and substitutions within the spirit and scope of the appended claims.

### REFERENCES

Chubb, D. L. and Lowe, R. A., J. Appl. Phys. 74, (9), 5687 (1993).

Chubb, D. L., Pal, A. T., Patton, M. O., and Jenkins, P. P., J. European Ceramic Soc. 19, 2551, (1999).

Fok, M. V., Incndescent Lamp With a Glower Made of an Alloyed Semiconductor Material, U.S. Pat. No. 3,502,930, (Mar. 24, 1970).

McIntosh, D. R., Multielement Selective Emitter, U.S. Pat. No. 6,018,216, (Jan. 25, 2000).

Riseberg, L. A., Candolumiscent Electric Light Source, U.S. Pat. No. 4,539,505, (Sep. 3, 1985).

Ropp, R. C., The Chemistry of Artifical Lighting Devices (Elsevier, N.Y., 1993).

Solomon, M., Electric Lamps, P. 138-175 (D. van Nostrand, N.Y., 1912).

Warren, R. W., Feldman, D. W., Incandescent Source of Visible Radiation, U.S. Pat. No. 3,973,155, (Aug. 3, 1976).

1. An incandescent electromagnetic radiation source comprising:
a) a non-metallic emitter body that conducts electricity,
b) an emitting volume within said emitter body that has a thermal energy, optical absorption coefficients, and optical scattering coefficients, and that generates and externally emits electromagnetic radiation,
c) electric current application means for applying an electric current to said emitting volume such that a substantial portion of said thermal energy is generated within said emitting volume by electrical resistive heating of said emitting volume by said electric current,
d) said optical absorption coefficients having significantly larger values within a predetermined high emissivity portion of the electromagnetic spectrum than within a predetermined low emissivity portion of the spectrum,
e) said optical scattering coefficients having much larger values than said optical absorption coefficients within said predetermined low emissivity portion of the spectrum.

2. The radiation source of claim 1 wherein said emitter body is constructed from refractory materials selected from the group consisting of ceramics and semiconductors.

3. The radiation source of claim 1 wherein said current application means are electrodes that electrically connect said emitter body to electric power.

4. The radiation source of claim 3 wherein said electrodes are connected to said emitter body via electrically conducting spatial isolation terminals positioned between said emitter body and said electrodes, whereby said electrodes are physically separated from said emitter body.

5. The radiation source of claim 1 wherein said emitter body contains a hollow cavity and an electrical coil that radiates heat mounted within said cavity.

6. The radiation source of claim 3 further comprising electric ballast.

7. The radiation source of claim 6 wherein said electric ballast contains a device selected from the group consisting of diacs and triacs.

8. The radiation source of claim 1 wherein a heating coil is positioned in close spaced relation to said emitter body whereby said body is preheated to a predetermined turn-on temperature.

9. The radiation source of claim 8 further comprising at least one electrical switching module that switches an electrical power, and an electrical conduction sensing device connected such that when the electrical conduction of said emitter body changes, said conduction sensing device causes said electrical switching module to change the length of time said electrical power is switched on.

10. The radiation source of claim 9 wherein said electrical switching module decreases the length of time said electrical power is switched on when the electrical conduction of said emitter body increases.

11. The radiation source of claim 10 wherein said electrical switching module contains a device selected from the group consisting of diacs and triacs.

12. The radiation source of claim 1 wherein said predetermined high emissivity portion of the electromagnetic spectrum is within the visible region.

13. A method of incandescently generating electromagnetic radiation comprising the steps of
a) providing a nonmetallic emitter body that externally radiates electromagnetic energy and that has optical absorption coefficients and optical scattering coefficients such that said optical scattering coefficients are substantially larger than said optical absorption coefficients within a predetermined low emissivity portion of the electromagnetic spectrum,
b) using electrical resistive heating within said emitter body to convert a supplied electrical energy into a thermal energy,
c) arranging said absorption coefficients such that, within said emitter body, said thermal energy is converted into electromagnetic energy with an emissivity that is greater within a predetermined high emissivity portion of the electromagnetic spectrum than within a predetermined low emissivity portion of the spectrum,
d) providing an additional heating means that radiantly heats said emitter body.

14. The method of claim 13 further comprising providing separate thermal stabilization means whereby thermal runaway within said emitter body is prevented.

15. The method of claim 14, wherein said predetermined high emissivity portion of the electromagnetic spectrum is within the visible region, and said predetermined low emissivity portion of the spectrum is within the NIR region.

16. A resistance inverting switching device comprising:
a) a variable resistance element,
b) provisions for at least one output load within at least one output load circuit wherein each said load can conduct a load current,
c) at least one resistance sensing device whereby changes in the resistance of said variable resistance element is sensed,
d) at least one electronic switching module that switches said load current on and off,
e) electrical interconnections between said at least one switching module and said at least one resistance sensing device such that said switching module decreases the length of time that said load current is conducted by said output load when the electrical resistance of said variable resistance element decreases, and increases the length of time that said load current is conducted by said output load when the electrical resistance of said variable resistance element increases.

17. The resistance inverting switching device of claim 16 wherein one of said at least one output load is said variable resistance element.

18. The resistance inverting switching device of claim 17 further comprising at least one additional switching module that modifies the configuration of said at least one output load circuit in response to the change in resistance of said variable resistance element.

19. The resistance inverting switching device of claim 18 wherein said one additional switching module modifies the configuration of said at least one output load circuit by providing a series resistance within said output load circuit.

20. The resistance inverting switching device of claim 19 wherein said electronic switching module contains a device selected from the group consisting of diacs and triacs.
